(19) United States
(12) Patent Application Publication
(10) Pub. No.: US 2010/0049664 A1
(43) Pub. Date: Feb. 25, 2010

(54) Method and system for user-defined alerting of securities information

(76) Inventor: Yi-Hsuan Kuo, Taipei City (TW)

Correspondence Address: Raymond Sun, 12420 Woodhall Way, Tustin, CA, 92782, US

(21) Appl. No.: 12/229,481

(22) Filed: Aug. 21, 2008

(51) Int. Cl. G06Q 40/00

(52) U.S. Cl. 705/36 R

(57) ABSTRACT

A method for user-defined alerting of securities information allows a user to create in advance a plurality of different alert conditions, such as a traded price, a percentage price change or a traded volume of a specific stock that has reached a preset value. Each of the alert conditions corresponds to a color background. Upon receipt of incoming real-time securities data or downloading of user-defined securities data from a database, a value in each data cell of the securities data is checked for conformity with a corresponding one of the alert conditions. If a specific alert condition is satisfied, a color background corresponding to the specific alert condition is applied to the corresponding data cell to produce a direct and prominent alerting effect.

### BACKGROUND OF INVENTION

1. Field of the Invention

The present invention relates to a method and system for user-defined alerting of securities information, and more particularly, to a method and system for user-defined alerting of securities information wherein securities information satisfying different alert conditions is highlighted by a plurality of colors respectively.

2. Description of the Prior Art

With rapid advancement of information technology, demands for real-time and convenient communication and access to information have shown explosive growth. In response to such demands, a variety of portable wireless communication devices having diversified functions have been constantly developed to satisfy users' needs and bring convenience to their daily lives. These communication devices include various kinds of cellular phones, smart phones, handheld stock managers and personal digital assistants (PDAs) capable of mobile communications, to name only a few.

In addition to the various wireless communication devices mentioned above, software and functions to be run and performed on such devices are also developed continuously, allowing users to manage their financial affairs, work, entertain themselves or access information at any time and at any place in a more convenient and more instant way. For example, wireless communication devices can be used to perform electronic transactions in securities such as stocks or futures. Besides placing electronic orders, another indispensable, major function of these wireless communication devices used for carrying out electronic transactions in securities such as stocks or futures is to provide real-time alert regarding the timing of securities transaction, helping the users to pinpoint the optimal timing for transaction in the vast amount of securities information.

As shown in FIG. 1, for a conventional wireless communication device 10 capable of conducting electronic transactions in securities such as stocks, the most common way of alerting of securities information is to highlight a price cell 11 with a specific color background (for example, a bright red color is used in Taiwan Stock Exchange) when a corresponding stock price increases by a percentage greater than a specific percentage (such as +7%). On the other hand, if a stock price falls by a percentage greater than a specific percentage (such as −7%), a corresponding price cell will be highlighted with another color background (a bright green color is used in Taiwan Stock Exchange, for example), thereby drawing a user's attention and achieving an alerting effect. As another conventional way of alerting of securities information, an additional alert cell 12 is displayed on a screen of the wireless communication device for showing preset alerting characters or symbols, such as a letter V indicating an unusually huge volume, a letter L indicating a traded price lower than a preset low price and a letter H indicating a traded price higher than a preset high price. The major drawback with the aforesaid two conventional ways of alerting is that only extreme price and volume conditions, such as a stock price hitting an upper or lower price change limit or an unusually huge volume, are shown, whereas intermediate levels of stock price changes and traded volumes are not presented. Moreover, the use of characters and symbols does not provide an alerting effect as direct and prominent as when specific color backgrounds are used in highlighting a specific data cell.

### SUMMARY OF INVENTION

A primary objective of the present invention is to provide a method and system for user-defined alerting of securities information, wherein securities information satisfying different alert conditions is highlighted by a variety of color backgrounds respectively, thereby producing a direct and prominent alerting effect.

In order to achieve the aforementioned objective, the present invention discloses a method and a system for user-defined alerting of securities information, which allows a user to create in advance a plurality of different alert conditions, such as a traded price, a percentage price change or a traded volume of a specific stock that has reached a preset value. Each of the alert conditions corresponds to a color background. Upon receipt of incoming real-time securities data or downloading of user-defined securities data from a database, a value in each data cell of the securities data is checked for conformity with a corresponding one of the alert conditions. If a specific alert condition is satisfied, a color background corresponding to the specific alert condition is applied to the corresponding data cell to produce a direct and prominent alerting effect.

In a preferred embodiment, when the securities data is real-time securities quotation data and a value in any one of the data cells is found to satisfy any corresponding alert condition, then the following step is further performed:

generating a pop-up prompt message and an alert signal, wherein the alert signal comprises at least one of the following: generating an alerting sound, generating an alerting vibration, and flickering the color background that has been applied to the data cell.

In a preferred embodiment, several ones of the alert conditions correspond to a same one of the data cells, and each of the alert conditions corresponds to a priority status which represents an order of priority in applying the alert conditions, such that when a value in the same one of the data cells satisfies at least two of the alert conditions, one of the color backgrounds that corresponds to one of the at least two alert conditions which has a higher priority status is applied to the data cell.

In a preferred embodiment, the color backgrounds corresponding to the several ones of the alert conditions that correspond to the same one of the data cells have a same hue but different shades, and the higher the priority status of one of the alert conditions is, the darker the shade of the corresponding one of the color backgrounds is.

In a preferred embodiment, when the same one of the data cells of the securities data is a stock price cell, the several ones of the alert conditions can be one of a percentage price change greater than a preset percentage, a highest price in a year, a lowest price in a year, a highest price in a quarter and a lowest price in a quarter; and when the same one of the data cells of the securities data is a stock volume cell, the several ones of the alert conditions can be one of a largest volume in a year, a largest volume in a quarter, a volume larger than an annual average volume and a volume larger than a quarterly average volume.

In a preferred embodiment, a percentage change, a base period for the highest prices or the lowest prices, and a base period for the largest volumes or the average volumes of the several alert conditions can be set by a user, and wherein the color background corresponding to each of the alert conditions can also be set by the user.

### BRIEF DESCRIPTION OF THE DRAWINGS

The present invention as well as a preferred mode of use, further objectives and advantages thereof will best be understood by reference to the following detailed description of illustrative embodiments when read in conjunction with the accompanying drawings, wherein:

FIG. 1 is a schematic drawing showing a conventional way of alerting of securities information;

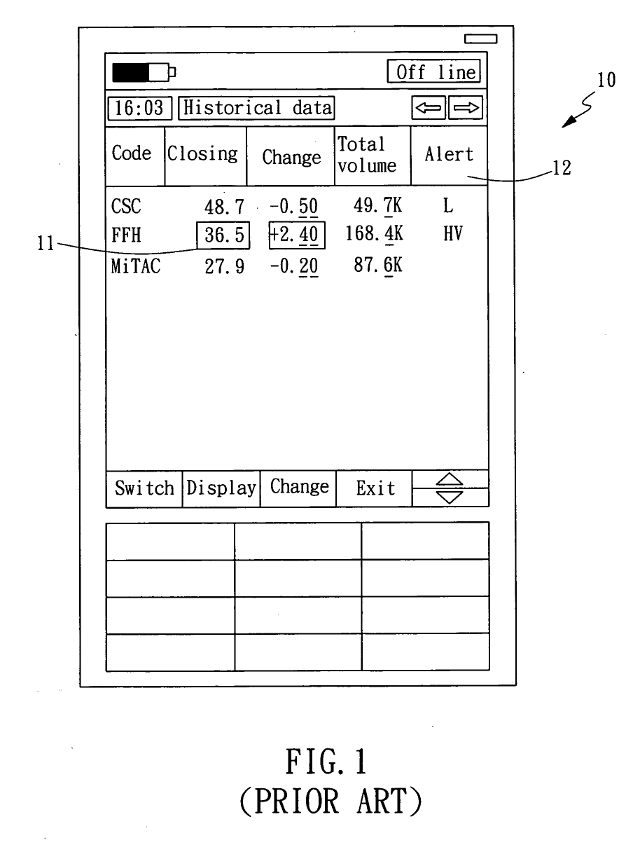

FIG. 2 is a schematic drawing of a system for user-defined alerting of securities information according to a preferred embodiment of the present invention;

FIG. 3 is a schematic drawing of securities data displayed on the system for user-defined alerting of securities information according to the preferred embodiment of the present invention;

FIG. 4 is a schematic drawing showing a plurality of color backgrounds and their corresponding alert conditions according to the preferred embodiment of the present invention; and

FIG. 5 is a flowchart of a method for user-defined alerting of securities information according to a preferred embodiment of the present invention.

### DETAILED DESCRIPTION OF THE PREFERRED EMBODIMENT

A primary principle of the present invention is to provide a method (and system) that allows a user to create in advance a plurality of different alert conditions, such as a traded price, a percentage price change or a traded volume of a specific stock that has reached a preset value. Each of the alert conditions corresponds to a color background. Upon receipt of incoming real-time securities data or downloading of user-defined securities data from a database, a value in each data cell of the securities data is checked for conformity with a corresponding one of the alert conditions. If a specific alert condition is satisfied, a color background corresponding to the specific alert condition is applied to the corresponding data cell to produce a direct and prominent alerting effect.

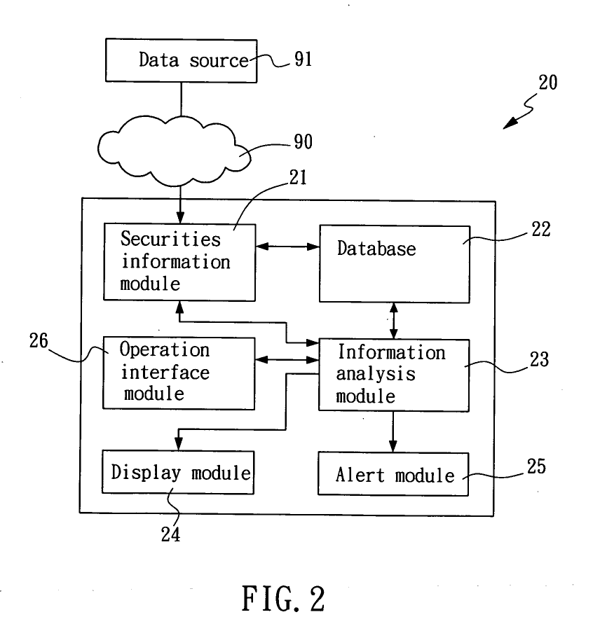

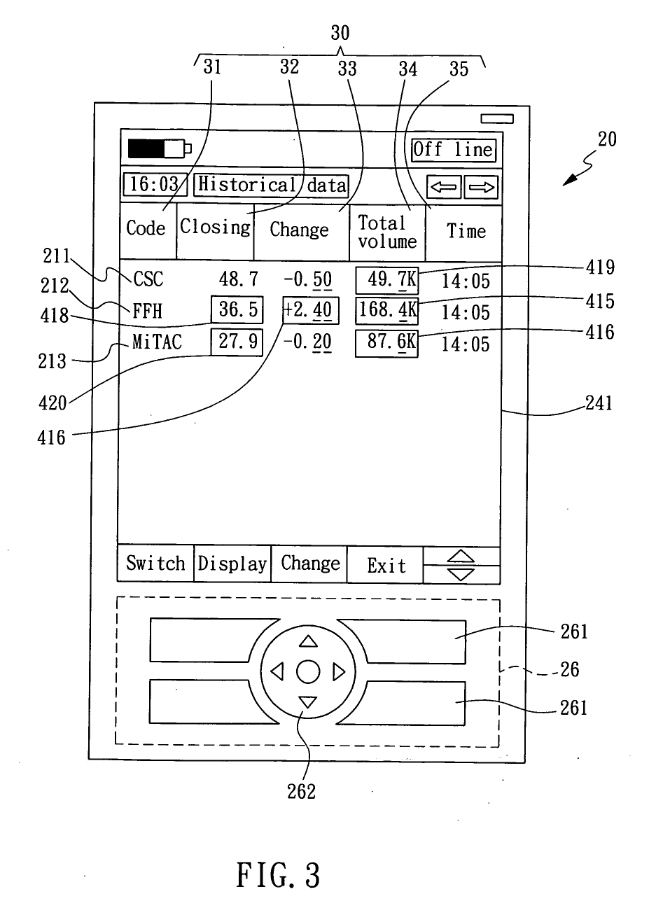

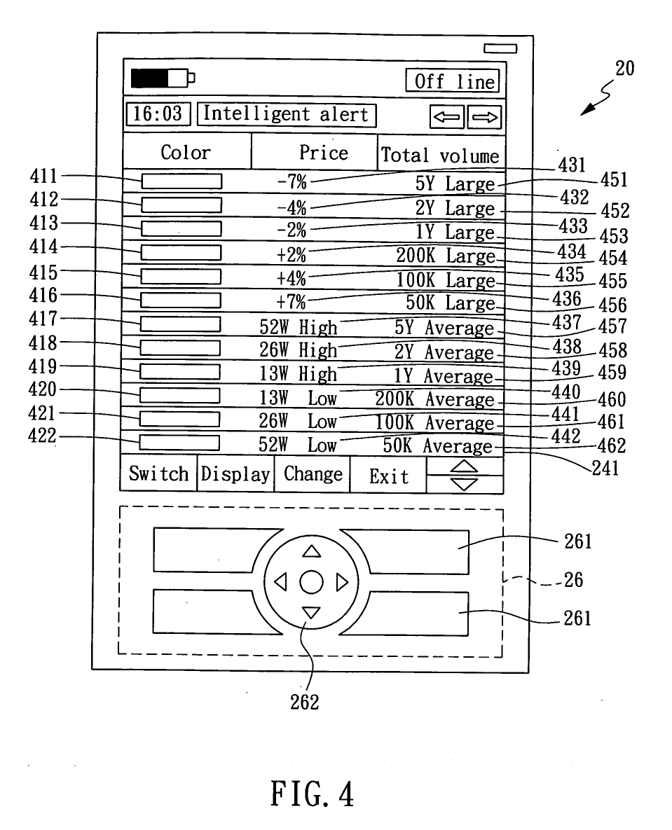

Referring to FIGS. 2, 3 and 4, FIG. 2 is a schematic drawing of a system for user-defined alerting of securities information according to a preferred embodiment of the present invention; FIG. 3 is a schematic drawing of securities data displayed on the system for user-defined alerting of securities information according to the preferred embodiment of the present invention; and FIG. 4 is a schematic drawing showing a plurality of color backgrounds and their corresponding alert conditions according to the preferred embodiment of the present invention.

Basically, a system 20 for user-defined alerting of securities information according to the present invention can receive a plurality of entries of real-time or historical securities data from a securities data source 91 via a transmission interface 90. In the preferred embodiment of the present invention, the system 20 for user-defined alerting of securities information is directed to a handheld wireless communication device capable of receiving and processing securities information through wireless communication, including but not limited to a smart phone, a handheld stock manager, or a personal digital assistant (PDA) having mobile communication functions. The system 20 can be connected with the transmission interface 90 in a wire-based or wireless manner, thereby connecting with the securities data source 91 for transmission of securities data. The transmission interface 90 can be, for example, a mobile communication network such as GPRS (General Packet Radio Service) and 3G (third-generation mobile communication network), or a wireless local area network such as WiFi (Wireless Fidelity), or a wireless wide area network such as WiMax (Worldwide Interoperability for Microwave Access), or a wire-based LAN (Local Access Network). On the other hand, the securities data source 91 can be, for example, a financial service provider, a securities transaction service provider, a telecommunication company or a securities exchange company. The securities data source 91 can provide real-time or historical securities data, including but not limited to real-time stock exchange information and historical stock exchange records.

In the embodiment shown in FIG. 2, the system 20 for user-defined alerting of securities information according to the present invention comprises a securities information module 21, a database 22, an information analysis module 23, a display module 24, an alert module 25 and an operation interface module 26.

The securities information module 21 is configured to connect with the external transmission interface 90, thereby connecting with the external securities data source 91 and receiving therefrom at least one entry of securities data 21 1, 212, 213, including but not limited to real-time quotation data, historical transaction data, technical analysis data or user-defined tabulated data of securities. As shown in FIG. 3, each entry of the securities data 211, 212, 213 has a plurality of data cells 30, including but not limited to a stock code cell 31, a traded (or closing) price cell 32, a percentage price change cell 33, a traded volume cell 34 and a time cell 35.

The database 22 is connected with the securities information module 21 and stores a plurality of different alert conditions, a plurality of different color backgrounds and the securities data 211, 212, 213 received by the securities information module 21. These alert conditions and color backgrounds are stored as digital data in the database. FIG. 4 is a schematic drawing showing of the plurality of color backgrounds 411-422 (colors) and their corresponding alert conditions 431-442 (price conditions) and 451-462 (total-volume conditions) according to the preferred embodiment of the present invention. The database 22 is created in a memory device, including but not limited to a flash memory or a hard drive.

The information analysis module 23 is connected with the securities information module 21 and the database 22, and serves to check values in data cells 31-35 of the securities data 211-213 against the alert conditions 431-442 (price conditions) or 451-462 (total-volume conditions) and determine whether any of the alert conditions is satisfied. If a value in any of the data cells 31-35 of the securities data 211-213 satisfies a corresponding one of the alert conditions 431-442 or 451-462, one of the color backgrounds 411-422 that corresponds to a matching one of the alert conditions is applied to the corresponding one of the data cells 31-35. As shown in FIG. 3, the securities data 212 has a closing price satisfying a 26W High condition, so that a color background 418 is applied to a corresponding closing price cell 32. Meanwhile, the same securities data 212 has a percentage price change reaching +7% (e.g., +2.40 in value for a deal price of 36.5) and a total traded volume more than satisfying a 100K Large condition. Therefore, a corresponding percentage price change cell 33 and a corresponding total volume cell 34 are shown respectively with a color background 416 and a color background 415. In this embodiment, the information analysis module 23 comprises a microprocessor. Moreover, a central control unit for controlling the overall operation of the system 20 for user-defined alerting of securities information can be built in the information analysis module 23 or connected therewith.

The display module 24 is connected with and controlled by the information analysis module 23, and configured to highlight specific data cells on a screen 241 with corresponding ones of the color backgrounds 411-422, according to a checking result of the information analysis module 23. General examples of the screen 241 include a thin film transistor liquid crystal display (TFT LCD), a color super-twisted nematic LCD (STN LCD), a plasma display device, a projector, a monitor, etc.

The alert module 25 is connected with the information analysis module 23 and can generate an alert signal when a value in any of the data cells 31-35 is found to satisfy a corresponding one of the alert conditions 431-442 or 451-462. The alert signal includes at least one of the following: showing a pop-up message block on the screen 241, generating an alerting sound, causing an alerting vibration and flickering those of the color backgrounds 411-422 that are applied to the data cells 31-35.

The operation interface module 26 is connected with the information analysis module 23 and allows a user to operate the system 20 for user-defined alerting of securities information and change parameters in the alert conditions 431-442 or 451-462. More particularly, a percentage change, a base period for the highest or lowest prices, and a base period for the largest or average volumes can all be set by the user via the operation interface module 26. In addition, the user can also set the color backgrounds 411-422 corresponding to the alert conditions 431-442 or 451-462 via the operation interface module 26, such as by using a color palette software. Moreover, the operation interface module 26 can comprise a plurality of function keys 261 and a direction key 262, or use a touch screen panel.

In the preferred embodiment of the present invention, the conventional ways of alerting of securities information (such as popping up a prompt message, generating an alerting sound, causing an alerting vibration, providing an additional alert cell for showing alerting characters and symbols, etc.) can coexist with the ways of alerting according to the present invention, while the user is allowed to set the priorities in all the ways of alerting.

Referring to FIGS. 3 and 4, in this embodiment, each of the alert conditions 431-442 or 451-462 can correspond to only one or several different ones of the data cells 31-35 of the securities data 211-213 and serve as a criterion for checking the value(s) in the corresponding one(s) of the data cells 31-35. In this embodiment, the alert conditions 431-442 or 451-462 can be divided into two categories: a “price category” (alert conditions 431-442) and a “total volume category” (alert conditions 451-462). For any data cell that falls into the price category, be it a data cell showing an opening price, a closing price, a rise or fall of prices, a percentage price change, a highest price, a lowest price or a price at each time point in a detailed screen, if a value in that data cell satisfies a specific alert condition in the price category, such as a percentage price change of +4%, a color background corresponding to that specific alert condition, such as the alert condition 435 specifying a percentage price change of +4%, can be applied to that data cell. When a price data cell simultaneously satisfies a plurality of the alert conditions in the price category, the alert condition having the highest priority will apply, as discussed later in more detail. The same principle is applicable to the alert conditions 451-462 in the total volume category, so that all data cells regarding “volume” are subject to the alert conditions 451-462 in the total volume category.

Now taking another point of view, if a data cell of the securities data 211-213 is a price cell 32 showing a stock price (such as a bid price, an ask price, a traded price or a closing price), then an applicable alert condition is one of the alert conditions in the price category, including: a percentage price change greater than a preset percentage (such as −7%, −4%, −2%, +2%, +4%, or +7%) (alert conditions 431-436); the highest price in a year or 52 weeks (52 W) (alert condition 437); the highest price in half a year or 26 weeks (26 W) (alert condition 438); the highest price in a quarter or 13 weeks (13 W) (alert condition 439); the lowest price in a quarter or 13 weeks (13 W) (alert condition 440); the lowest price in half a year or 26 weeks (26 W) (alert condition 441); and a lowest price in a year or 52 weeks (52 W) (alert condition 442). On the other hand, if a data cell of the securities data 211-213 is a traded volume (total volume) cell 34 showing a stock transaction volume, then an applicable alert condition is one of the alert conditions in the total volume category, including: the largest volume in five years (5Y) (alert condition 451); the largest volume in two years (2Y) (alert condition 452); the largest volume in one year (1Y) (alert condition 453); a volume larger than a huge volume of 200 thousand shares (200K) (alert condition 454); a volume larger than a huge volume of 100 thousand shares (100K) (alert condition 455); a volume larger than a huge volume of 50 thousand shares (50K) (alert condition 456); a volume larger than a five-year (5Y) average volume (alert condition 457); a volume larger than a two-year (2Y) average volume (alert condition 458); a volume larger than a one-year (1Y) average volume (alert condition 459); an average volume larger than 200 thousand shares (200K) (alert condition 460); an average volume larger than 100 thousand shares (100K) (alert condition 461); an average volume larger than 50 thousand shares (50K) (alert condition 462); the largest volume in a quarter; a volume larger than an annual average volume; a volume larger than a quarterly average volume; etc.

As can be known from the schematic drawing in FIG. 4 showing the plurality of color backgrounds 411-422 and their corresponding alert conditions 431-442 or 451-462 according to the preferred embodiment of the present invention, several of the alert conditions may correspond to the same data cell. Therefore, when a data cell simultaneously satisfies more than one alert conditions, such as when a traded (closing) price data 32 corresponding to a specific stock code simultaneously satisfies the alert conditions of a percentage price change of +7% and the highest price in 13 weeks, one of the two alert conditions must be chosen as having a higher priority so that a color background corresponding to that specific alert condition is displayed. Hence, in the preferred embodiment of the present invention, each of the alert conditions 431-442 and 451-462 further corresponds to a priority status, which reflects an order of priority in applying the alert conditions 431-442 and 451-462. For example, the order of priority includes but is not limited to the alert condition 438 for the highest price in 26 weeks having a higher priority than the alert condition 436 for a percentage price change greater than +7%. Therefore, as shown in FIG. 3, when a value in the data cell 32 corresponding to a specific stock code 212 simultaneously satisfies at least two different alert conditions, such as the alert conditions 436 and 438, the information analysis module 23 of the system 20 for user-defined alerting of securities information of the present invention will automatically use the color background 418 corresponding to the higher-priority alert condition 438 to highlight the data cell 32 corresponding to the stock code 212 on the screen 241. Furthermore in this embodiment, in order to allow a user to discriminate instinctively the meaning and significance of each of the color backgrounds 411-422, those of the color backgrounds that fall into the same category and may correspond to the same data cell have a same hue but differentiate from one another by different shades, wherein an alert condition having a higher priority corresponds to a darker color background. For example, the alert conditions 431, 432 and 433 specifying respectively percentage price changes of −7%, −4% and −2% (as shown in a price column in FIG. 4) correspond to color backgrounds of a dark red color 411, a medium red color 412 and a light red color 413, respectively. Meanwhile, the alert conditions 434, 435 and 436 specifying respectively percentage price changes of +2%, +4% and +7% (as shown in the price column in FIG. 4) correspond to color backgrounds of a light green color 414, a medium green color 415 and a dark green color 416, respectively. In addition, the alert conditions 437, 438 and 439 specifying respectively 52 W High, 26 W High and 13 W High in the price column in FIG. 4 correspond to color backgrounds of a dark orange color 417, a medium orange color 418 and a light orange color 419, respectively. By contrast, the alert conditions 440, 441 and 442 specifying respectively 13 W Low, 26 W Low and 52 W Low correspond to color backgrounds of a light blue color 420, a medium blue color 421 and a dark blue color 422, respectively. It is understood that the aforesaid color backgrounds and alert conditions are illustrative embodiments only and can be set and changed by the user, and that these embodiments are not intended to limit the scope of applications of the present invention. Moreover, the use of the color backgrounds to mark the alert conditions is applicable not only to the example shown in FIG. 3 wherein user-defined tabulated content is displayed. The user-defined tabulated content is only one of some common examples and not the sole example. No matter what operation mode the system is in, as long as there is a data cell displayed on the screen that can be compared with the alert conditions, the data cell can be highlighted with a color background corresponding to one of the alert conditions that is satisfied.

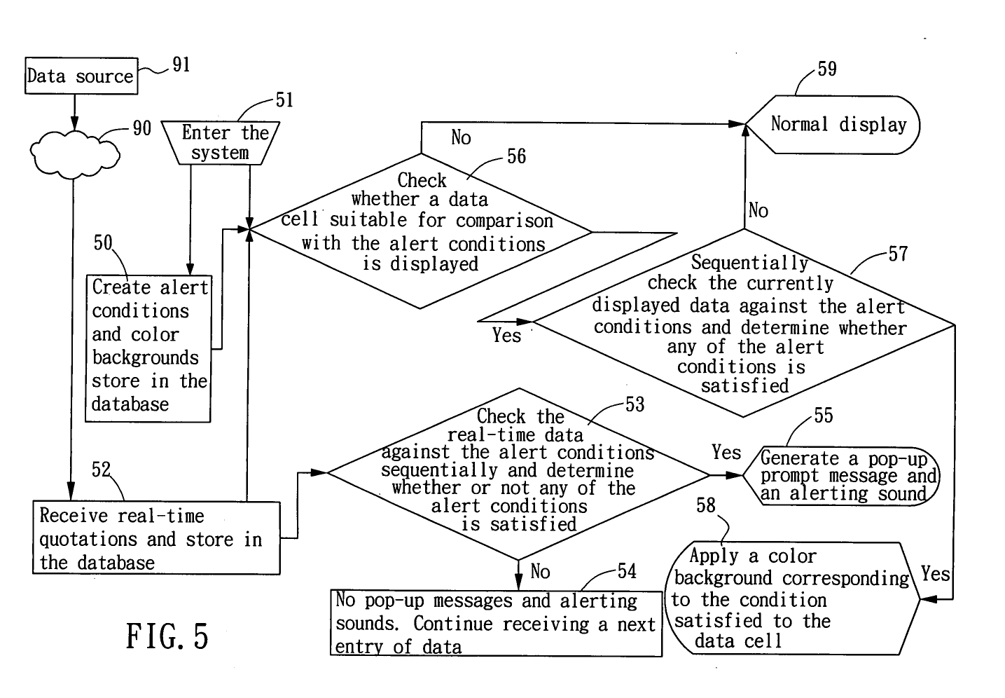

Referring to FIG. 5, a flowchart of a method for user-defined alerting of securities information according to a preferred embodiment of the present invention comprises the following two paths.

A path 1 includes steps 52, 53, 54 and 55 in a lower half of FIG. 5 and is a daemon program that runs in a background mode as long as the system 20 for user-defined alerting of securities information according to the present invention is connected with a server (such as the data source 91) and receiving real-time data therefrom, regardless of contents displayed on the screen 241. Serving a simple purpose of receiving data, the path in the lower half of FIG. 5 can be viewed as a lower-level program that keeps on functioning in the background mode regardless of the contents displayed on a user interface. Only when a checking result shows that an alert needs to be delivered (step 53) will a dialog block pop up or an alerting sound be generated to cover the contents currently in display (step 55). In other words, the path 1 works independently and there is no need in the path 1 to check whether or not a data cell suitable for being compared with the alert conditions is displayed on the screen 241.

A path 2 includes steps 56, 57, 58 and 59 in an upper half of FIG. 5 and is executed only when a data cell suitable for being compared with the alert conditions is displayed on the screen 241. The path 2 will be executed even in an off-line state as long as the screen 241 currently displays a data cell suitable for being compared with the alert conditions. The path in the upper half of FIG. 5 is a program for processing the user interface and can be regarded as lying at an upper level of the application software. Whenever the user switches the contents in display, the path 2 will check whether or not a data cell suitable for being compared with the alert conditions is displayed (step 56). If yes, the process goes on to steps 57 and 58.

A connection between the step 52 in the lower path and the step 56 in the upper path is now explained. When the data-receiving program in the lower path receives new data (step 52), a user interface program in the upper path is notified to refresh the contents in display, so that values in the data cells currently in display are updated. Then the step 56 is executed to check whether or not a data cell suitable for being compared with the alert conditions is displayed. If yes, the process moves on to a next step (steps 57 and 58).

The steps in the flowchart of FIG. 5 are now explained in more detail.

Step 50 [Create alert conditions and color backgrounds]: A plurality of different alert conditions and a plurality of different color backgrounds are created in the system in advance and stored in a database of the system, wherein each of the alert conditions corresponds to one of the color backgrounds. The corresponding alert conditions and color backgrounds can be conditions and colors set or edited by the user, or alternatively, preset conditions and colors created and stored in advance in the database of the system for user-defined alerting of securities information according to the present invention.

Step 51 [Enter the system]: The user enters the system and uses such functions as receiving or browsing securities data and creating alert conditions and color backgrounds.

Step 52 [Receive real-time quotations and store in the database]: After the user enters the system, a securities information module connects the system to an external securities data source 91 via a transmission interface 90, so that the system receives at least one entry of securities data (such as real-time stock quotations or historical transaction data) and store the securities data in the database of the system, wherein each entry of the securities data has a plurality of data cells. In addition, each of the alert conditions corresponds to one or more than one of the data cells and serves as a criterion for checking the value(s) in the corresponding data cell(s). According to the present invention, the system will continue receiving data in the background mode after the system is successfully connected with the server. This background-mode action is independent of operation of the user interface or contents currently displayed on a screen of the system. The system will keep on receiving real-time data and storing the data into the database regardless of the contents currently displayed on the screen.

Step 53 [Check the real-time data against the alert conditions sequentially and determine whether or not any of the alert conditions is satisfied]: In step 53, the system begins an automatic checking process that runs in the background mode, so that an information analysis module sequentially checks values in the data cells of the securities data received in real time against each of the alert conditions, and determines whether or not the values in the respective data cells satisfy any of the alert conditions. If a value in any of the data cells of the securities data satisfies a corresponding one of the alert conditions, a step 55 will be executed; otherwise, a step 54 will be executed instead. In the step 53, the system will determine whether or not any of the data cells satisfies a corresponding one of the alert conditions as soon as the system receives real-time data in the background mode, regardless of the contents displayed on the screen, provided the system is connected with the server.

Step 54 [No pop-up messages and alerting sounds. Continue receiving a next entry of data]: If none of the data is found to satisfy a corresponding one of the alert conditions in the step 53, there is no need to generate any alerts or pop-up messages. The step 52 of receiving real-time quotations will continue.

Step 55 [Generate a pop-up prompt message and an alerting sound]: If it is determined in the step 53 that a specific entry of real-time data satisfies a corresponding one of the alert conditions, the system will automatically generate a pop-up prompt message or an alerting sound (or vibration) to notify the user that a value in a specific real-time data cell is found in the step 53 to satisfy a corresponding one of the alert conditions. According to the present invention, the generation of the pop-up prompt message or the alerting sound (vibration) as a way of alerting is not limited by the data currently displayed on the screen and can be carried out regardless of the contents displayed.

Step 56 [Check whether a data cell suitable for being compared with the alert conditions is displayed]: The system determines whether or not a data cell suitable for being compared with the alert conditions is displayed on the screen. The system for user-defined alerting of securities information according to the present invention comprises various operation modes and display contents that serve different functions. For example, these operation modes and display contents include user-defined tables, real-time charts, details of real-time transactions, after-hour candlestick charts, company profiles, financial reports, buy/sell records of brokers, monthly revenue data, etc. The step 56 determines whether or not the screen is displaying any data cell (such as in a user-defined table) that is suitable for being compared with the alert conditions. If yes, a step 57 will be executed; it not, a step 59 will be executed. According to the present invention, the aforesaid checking process of the step 56 will be performed more than once. Whenever the user switches the display contents, the system automatically performs the checking process of the step 56. If the system finds a data cell suitable for being compared with the alert conditions is currently in display, the step 57 will be executed; otherwise, the step 59 will be executed instead.

Step 57 [Sequentially check the currently displayed data against the alert conditions and determine whether any of the alert conditions is satisfied]: In step 57, the information analysis module sequentially retrieves from the database values in the data cells of each entry of the user-defined securities data (real-time data or historical data), so that the values are displayed on the screen. Meanwhile, the system checks whether or not the values in the respective data cells displayed on the screen satisfy any of the alert conditions. If a value in any of the data cells of the securities data satisfies a corresponding one of the alert conditions, a step 58 is executed; otherwise, a step 59 is executed instead. It is worth mention that, even though the system is performing the aforesaid checking process in the step 57, the step 53 of checking real-time data is executed simultaneously in the background mode as long as the step 52 of receiving real-time data is executed continuously in the background mode.

Step 58 [Apply a color background corresponding to the condition satisfied to the data cell]: If it is found in the step 57 that a specific data cell currently displayed on the screen satisfies a corresponding one of the alert conditions, the system will apply one of the color backgrounds that corresponds to that alert condition to that specific data cell for the purpose of alerting. In this embodiment, it is worth mention that, while the system is executing the step 58 of applying a color background corresponding to the condition satisfied to the data cell, a pop-up prompt message and an alerting sound (vibration) may be generated simultaneously as desired, so that the user is easily aware that the system has found a value in a specific data cell that satisfies a specific alert condition.

Step 59 [Normal display]: Since the checking result of the step 56 or the step 57 is “no”, the system will resume normal display, such as by applying a normal color background (usually a transparent background or a background of a dark color such as black) to the data cells displayed.

Tables 1 and 2 show embodiments of data structures used in the method for user-defined alerting of securities information according to the present invention.

TABLE 1
An embodiment of a securities data structure of the present
invention

| Item | Data length (bytes) |
|---|---|
| Stock ID (Stock code) | 2 |
| High price (Profiting price) | 4 |
| Low price (Loss-stopping | 4 |
| price) | |
| Huge volume (Unusual | 4 |
| volume) | |
| Total Data Length | 14 |

If the user selects 100 securities in the watch list, then 100 securities data each having a data structure described in Table 1 are stored.

TABLE 2
An embodiment of an alert condition data structure of the
present invention

| Item | Data length (bytes) |
|---|---|
| Condition ID | 1 |
| Priority | 1 |
| Corresponding color | 2 |
| background | |
| Total data length | 4 |

Each of the alert conditions stored has a data structure described in Table 2. In addition, each of the price cell and the traded volume cell of the securities data corresponds to a plurality of such alert condition data structures. Besides, in this embodiment, all the user-defined stock data shares a common setting value.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for user-defined alerting of securities information, comprising steps of:
creating a plurality of different alert conditions and a plurality of different color backgrounds, each of the alert conditions corresponding to one of the color backgrounds;
receiving at least one entry of securities data, each entry having a plurality of data cells, wherein each of the alert conditions corresponds to at least one of the data cells and serves as a criterion for checking a value in the at least one of the data cells; and
checking a value in each of the data cells of the securities data and, if a value in any one of the data cells of the securities data satisfies a corresponding one of the alert conditions, applying one of the color backgrounds that corresponds to the alert condition satisfied to the data cell.

2. The method for user-defined alerting of securities information as claimed in claim 1, wherein the alert conditions and the color backgrounds are stored as digital data in a database, and the securities data is one of the following: real-time securities quotation data, historical securities transaction data and user-defined tabulated securities data.

3. The method for user-defined alerting of securities information as claimed in claim 2, wherein, when the securities data is real-time securities quotation data and a value in any one of the data cells is found to satisfy any corresponding alert condition, then the following step is further performed:
generating a pop-up prompt message and an alert signal, wherein the alert signal comprises at least one of the following: generating an alerting sound, generating an alerting vibration, and flickering the color background that has been applied to the data cell.

4. The method for user-defined alerting of securities information as claimed in claim 1, wherein several ones of the alert conditions correspond to a same one of the data cells, and each of the alert conditions corresponds to a priority status which represents an order of priority in applying the alert conditions, such that when a value in the same one of the data cells satisfies at least two of the alert conditions, one of the color backgrounds that corresponds to one of the at least two alert conditions which has a higher priority status is applied to the data cell.

5. The method for user-defined alerting of securities information as claimed in claim 4, wherein the color backgrounds corresponding to the several ones of the alert conditions that correspond to the same one of the data cells have a same hue but different shades, and the higher the priority status of one of the alert conditions is, the darker the shade of the corresponding one of the color backgrounds is.

6. The method for user-defined alerting of securities information as claimed in claim 4, wherein, when the same one of the data cells of the securities data is a stock price cell, the several ones of the alert conditions can be one of a percentage price change greater than a preset percentage, a highest price in a year, a lowest price in a year, a highest price in a quarter and a lowest price in a quarter; and when the same one of the data cells of the securities data is a stock volume cell, the several ones of the alert conditions can be one of a largest volume in a year, a largest volume in a quarter, a volume larger than an annual average volume and a volume larger than a quarterly average volume.

7. The method for user-defined alerting of securities information as claimed in claim 6, wherein a percentage change, a base period for the highest prices or the lowest prices, and a base period for the largest volumes or the average volumes of the several alert conditions can be set by a user, and wherein the color background corresponding to each of the alert conditions can also be set by the user.

8. A system for user-defined alerting of securities information, comprising:
a securities information module for receiving from outside the system at least one entry of securities data, each entry having a plurality of data cells;
a database connected with the securities information module for storing a plurality of different alert conditions, a plurality of different color backgrounds and the securities data received by the securities information module, wherein each of the alert conditions corresponds to at least one of the data cells and serves as a criterion for checking a value in the at least one of the data cells;
an information analysis module connected with the securities information module and the database for checking a value in each of the data cells of the securities data, so that, if a value in any one of the data cells of the securities data satisfies a corresponding one of the alert conditions, one of the color backgrounds that corresponds to the alert condition satisfied is applied to the data cell; and
a display module connected with and controlled by the information analysis module, and configured to display a specific one of the data cells with a specific one of the color backgrounds according to a checking result.

9. The system for user-defined alerting of securities information as claimed in claim 8, wherein the database is created in a memory device, and the securities data is one of the following: real-time securities quotation data, historical securities transaction data and user-defined tabulated securities data.

10. The system for user-defined alerting of securities information as claimed in claim 8, further comprising:
an alert module connected with the information analysis module for generating an alert signal when a value in any of the data cells is found, via checking, to satisfy a corresponding one of the alert conditions; wherein the alert signal comprises at least one of the following: generating an alerting sound, generating an alerting vibration, and flickering the color background that has been applied to the data cell.

11. The system for user-defined alerting of securities information as claimed in claim 8, wherein several ones of the alert conditions correspond to a same one of the data cells, and each of the alert conditions corresponds to a priority status which represents an order of priority in applying the alert conditions, such that when a value in the same one of the data cells satisfies at least two of the alert conditions, one of the color backgrounds that corresponds to one of the at least two alert conditions which has a higher priority status is applied to the data cell.

12. The system for user-defined alerting of securities information as claimed in claim 8, wherein the color backgrounds corresponding to the several ones of the alert conditions that correspond to the same one of the data cells have a same hue but different shades, and the higher the priority status of one of the alert conditions is, the darker the shade of the corresponding one of the color backgrounds is.

13. The system for user-defined alerting of securities information as claimed in claim 8, wherein, when the same one of the data cells of the securities data is a stock price cell, the several ones of the alert conditions can be one of a percentage price change greater than a preset percentage, a highest price in a year, a lowest price in a year, a highest price in a quarter and a lowest price in a quarter; and when the same one of the data cells of the securities data is a stock volume cell, the several ones of the alert conditions can be one of a largest volume in a year, a largest volume in a quarter, a volume larger than an annual average volume and a volume larger than a quarterly average volume.

14. The system for user-defined alerting of securities information as claimed in claim 13, further comprising:
an operation interface module connected with the information analysis module for allowing a user to operate the system for user-defined alerting of securities information and change parameters in the alert conditions, and wherein the color background corresponding to each of the alert conditions can also be set by the user.

15. A method for user-defined alerting of securities information, comprising steps of:
(A) creating a plurality of different alert conditions and a plurality of different color backgrounds, each of the alert conditions corresponding to one of the color backgrounds;
(B) receiving at least one entry of securities data, each entry having a plurality of data cells, wherein each of the alert conditions corresponds to at least one of the data cells and serves as a criterion for checking a value in the at least one of the data cells;
(C) checking and determining whether or not any one of displayed data cells is suitable for being compared with the alert conditions, and proceeding to a step (D) if yes or proceeding to a step (F) if no;
(D) checking each of the displayed data cells against the alert conditions, determining whether or not a value in any one of the displayed data cells satisfies a corresponding one of the alert conditions, and proceeding to a step (E) if yes or proceeding to a step (F) if no;
(E) applying one of the color backgrounds that corresponds to the alert condition satisfied to the corresponding one of the displayed data cells; and
(F) keeping an original color background of each of the displayed data cells that does not satisfy any one of the alert conditions.

16. The method for user-defined alerting of securities information as claimed in claim 15, wherein the step (B) of receiving securities data is performed continuously in a background mode regardless of a content currently displayed, and the step (B) performed continuously in the background mode further comprises steps of:
(B1) sequentially checking a value in each of the data cells of the received securities data against each of the alert conditions, determining whether or not the value in any of the data cells of the securities data satisfies a corresponding one of the alert conditions, and proceeding to a step (B3) if yes or proceeding to a step (B2) if no;
(B2) continuing to perform the step (B) of receiving securities data while generating no alert messages or pop-up messages as none of the values in the data cells of the securities data is found in the step (B1) to satisfy the alert conditions; and
(B3) generating a pop-up prompt message or an alerting sound or vibration as an alert of a fact that a value in a specific one of the data cells of the securities data satisfies a specific one of the alert conditions.
